(19) United States
(12) Patent Application Publication
(10) Pub. No.: US 2016/0163280 A1
(43) Pub. Date: Jun. 9, 2016

(54) IMAGE LAYER COMPOSITION

(71) Applicant: Norman WEYRICH, Shanghai (CN)

(72) Inventor: Norman WEYRICH, Shanghai (CN)

(21) Appl. No.: 14/904,065

(22) PCT Filed: Jul. 16, 2013
(86) PCT No.: PCT/CN2013/079432

§ 371 Date: Jan. 8, 2016

(51) Int. Cl. G09G 5/00; G06T 1/20

(52) U.S. Cl. CPC G09G 5/001; G06T 1/20; G09G 2320/10; G09G 2352/00; G09G 2360/08; G09G 2360/18

(57) ABSTRACT

A method and a system for image layer composition are provided. The method may include detecting whether a plurality of computing devices of a computing system have available resource for performing image layer composition. The method also includes receiving a plurality of image layers and controlling at least one computing device detected having available resource for performing image layer composition to compose the plurality of image layers. Composition efficiency may be improved.

### TECHNICAL FIELD

The present disclosure generally relates to image layer composition.

### BACKGROUND

In modern computing systems such as personal computers and smartphones, one or more applications can run in parallel. These applications may create graphical contents into different so-called “image layers”, including RGB graphic, YUV video frames, and the like. These image layers are composed to generate a final image, and then the final image is displayed on a screen. Currently, composition of the image layers is usually performed using graphic processing unit (GPU) resources, central processing unit (CPU) resources or display controller hardware resources in a fixed mode. For example, image layers are composed solely by GPU(s), or solely by CPU, or solely by display controller.

### SUMMARY

Inventors found that in conventional methods, image layers are composed only by a dedicated computing device, and other available computing resources in the system are not used sufficiently. Therefore, a new image layer composition method is needed.

According to one embodiment, a method for image layer composition is provided. The method may include: detecting whether a plurality of computing devices of a computing system have available resource for performing image layer composition; receiving a plurality of image layers; and controlling at least one computing device detected having available resource for performing image layer composition to compose the plurality of image layers. Image layers may be composed by one or more computing devices detected having available resource instead of one or more dedicated computing devices, thus the computing resources can be used more sufficiently and composition efficiency can be improved.

In some embodiments, the plurality of computing devices of the computing system may include but not limited to a graphic processing unit (GPU), a central processing unit (CPU) and a display controller. In some embodiments, the plurality of computing devices may include at least two different types of devices. For example, the plurality of computing devices may include a CPU and a GPU, or a GPU and a display controller, or a CPU and a display controller, or a CPU, a GPU, and a display controller.

In some embodiments, the method may further include detecting how many image layers need to be composed, and the at least one computing device may be controlled to compose the plurality of image layers based on the detection of how many image layers need to be composed. In some embodiments, the method may further include determining computation capability required to compose the plurality of image layers, and the at least one computing device may be controlled to compose the plurality of image layers based on the determination.

In some embodiments, if more than one computing devices are detected having available resource, the computing devices detected having available resource may be controlled to compose the plurality of image layers based on their composition speeds and/or capabilities and computation loads.

In some embodiments, if more than one computing devices are detected having available resource, the computing devices detected having available resource may be respectively dedicated to compose image layers generated by different applications.

In some embodiments, computing devices with relatively high composition speeds may be dedicated to compose image layers generated by applications with relatively high image layer refresh rates.

According to one embodiment, a system for image layer composition is provided. The system may include a plurality of computing devices and a processing device, wherein the processing device may be configured to: detect whether the plurality of computing devices have available resource for performing image layer composition; and control at least one computing device detected having available resource for performing image layer composition to compose a plurality of image layers.

In some embodiments, the plurality of computing devices may include but not limited to a graphic processing unit (GPU), a central processing unit (CPU) and a display controller. In some embodiments, the plurality of computing devices may include at least two different types of devices.

In some embodiments, the processing device may be further configured to detect how many image layers need to be composed, and control the at least one computing device detected having available resource for performing image layer composition to compose the plurality of image layers based on the detection of how many image layers need to be composed. In some embodiments, the processing device may be further configured to detect computation capabilities required to compose the plurality of image layers, and control the at least one computing device detected having available resource for performing image layer composition to compose the plurality of image layers based on the detection of computation capabilities required to compose the plurality of image layers.

In some embodiments, if more than one computing devices are detected having available resource, the processing device may be configured to control the computing devices detected having available resource to compose the plurality of image layers based on their composition speeds and/or capabilities and computation loads.

In some embodiments, the processing device may be further configured to detect information of applications which generate the plurality of image layers and control the at least one computing device detected having available resource for performing image layer composition to compose the plurality of image layers based on the detection of information of applications.

In some embodiments, if more than one computing devices are detected having available resource, the processing device may be configured to dedicate the computing devices having available resource to compose image layers generated by different applications.

In some embodiments, the processing device may be configured to dedicate computing devices with relatively high composition speeds to compose image layers generated by applications with relatively high image layer refresh rates.

According to one embodiment, a non-transitory computer readable medium, which contains a computer program for controlling composition of a plurality of image layers, is provided. When the computer program is executed by a processor, it will instruct the processor to: detect whether a plurality of computing devices of a computing system have available resource for performing image layer composition; and control at least one computing device detected having available resource for performing image layer composition to compose the plurality of image layers.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1 schematically illustrates a flow chart of a method for image layer composition according to one embodiment;

FIG. 2 schematically illustrates structures of a display controller in a specific example; and

FIG. 3 schematically illustrates a block diagram of a system for image layer composition according to one embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

When composing a plurality of image layers generated by various applications running in parallel in a computing system, various computing devices, such as display controller resources, GPU resources, CPU resources, or the like, may be used. After the composition, an output image may be generated, which can be illustrated on a display screen. However, in conventional methods, the plurality of image layers are composed by dedicated computing devices. As a result, other available computing devices in the system are not used sufficiently.

In various embodiments, an efficient method for image layer composition is provided.

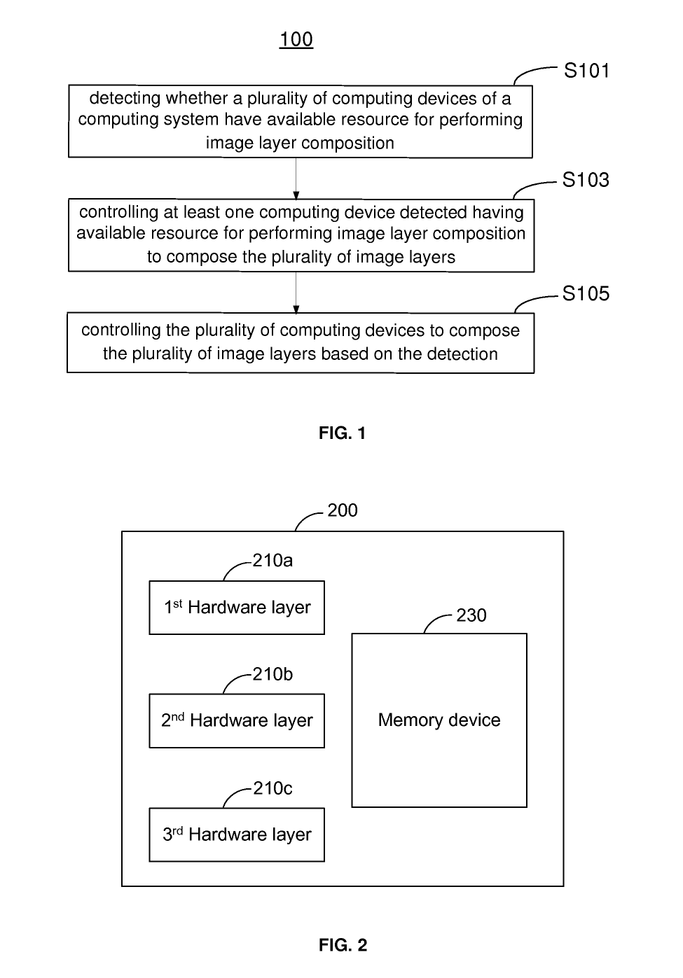

FIG. 1 schematically illustrates a method 100 for performing image layer composition.

In S101, detecting whether a plurality of computing devices of a computing system have available resource for performing image layer composition.

In the computing system, such as a personal computer, a smartphone, or the like, there may be several computing devices capable of performing image layer composition. The computing devices may include, but not limit to, a graphic processing unit (GPU), a central processing unit (CPU) and a display controller. However, some of the computing devices may be totally occupied or disabled at a certain time point, which means they have no available resource for performing image layer composition at the time point.

In some occasions, there may have no computing devices detected having available resource for performing image layer composition. If there are a plurality of image layers need to be composed, the composition may need to wait until at least one computing device has available resource for performing image layer composition, obviously. Normally, the computing devices may not be 100% occupied. For example, even the GPU or CPU is partially occupied to do some computation such as generating image layers, the rest computation resource may be available for composing image layers. Based on the detection, the available resources may be efficiently used.

In S103, detecting information of a plurality of image layers to be composed.

There may be various applications running in parallel in the computing system, generating contents to be visually illustrated. For example, in a computer, some applications may generate a background picture of the desktop, some applications may generate icons on the desktop, and some applications may generate windows including various information. These contents may be mapped into memory structures such as frame buffers, respectively, and would be composed (also called “blended”) by one or more computing devices before being illustrated on a display screen. These contents are respectively referred to as “image layers” of the applications, which is well known in the art.

In most computing systems, there is already designed a memory device for storing the image layers before the composition. Therefore, it may be more efficient and economic to detect the information of the plurality of image layers stored in the memory device. However, in some embodiments, the information of the plurality of image layers to be composed may be detected directly from applications generating the plurality of image layers.

In some embodiments, how many image layers need to be composed may be detected. In some embodiments, computation capabilities required to compose the plurality of image layers may be detected. In some embodiments, information of applications which generate the plurality of image layers may be detected. An efficient composition scheme may be formed by referring to these information and the above detection of which computing devices have available resource for performing image layer composition.

In S105, controlling at least one computing device detected having available resource for performing image layer composition to compose the plurality of image layers.

Based on the detection in S101 and S103, there may be several scenarios.

In some scenarios, there may be only one computing device detected having available resource. Thus the plurality of image layers may be sent to the only one computing device and composed therein.

In some scenarios, there may be more than one computing devices detected having available resource. In such scenario, there may be several ways to perform image layer composition.

In some embodiments, the plurality of computing devices detected having available resource may be controlled to compose the image layers based on their composition speed and/or capability. Different computing devices may have different speeds for image layer composition. For example, display controller, which implements hardware composition, may have a faster composition speed than GPU and CPU. Normally, the CPU has the lowest composition speed. In some embodiments, a computing device with a relatively fast composition speed may be used before a computing device with a relatively slow composition speed is used. For example, if the display controller is available and is capable of composing all the image layers, the composition may be performed by the display controller even the GPU or CPU is also available. However, in some embodiments, the compositions may be performed by the plurality of computing devices detected having available resource collaboratively, especially when the faster computing device is not capable of composing all the image layers.

Several architectures may be established for performing the collaborative compositions. In some embodiments, the composition may be performed based on the composition speeds and computation loads of the available computing devices. For example, the faster computing devices may be controlled to compose the image layers with more computation loads.

In some embodiments, the computing devices detected having available resource may be assigned to compose image layers generated by different applications. By dedicating a computing device to running applications, image layers subsequently generated by these running applications may be mapped to the computing device and composed therein. There may not be necessary to detect the availabilities of the computing devices in the computing system over and over again, since the available computing devices and running applications may not change within a certain period. This composition architecture may be more efficient. In some embodiments, the relatively fast computing devices, such as the display controller, may be designated to the running applications which have relatively high image layer refresh rates, such as a multimedia player, and the relatively slow computing devices may be designated to the running applications which have relatively low image layer refresh rates.

Hereunder gives a specific example to illustrate the collaborative composition.

It is well known in the art that display controllers implement hardware composition, which has a relatively fast speed. If a display controller has N (N is a natural number) ports open to be input with N image layers in parallel, and the N image layers can be composed in the display controller, it may be called that the display controller has N hardware layers. FIG. 2 schematically illustrates structures of a display controller 200 in the specific example. The display controller 200 was detected to have three available hardware layers 210a, 210b and 210c to implement image layer composition, while there were six image layers detected to be composed at the specific time point. In such scenario, two of the image layers from two running applications with higher image layer refresh rates were mapped into the 1^{st} and 2^{nd} two hardware layers 210a and 210b of the display controller 200, while the other four image layers from four running applications with lower image layer refresh rates were sent to the GPU to be composed therein. And the composition result of the four image layers were mapped into the 3^{rd} hardware layer 210c to be composed with the two image layers in the 1^{st} and 2^{nd} hardware layers 210a and 210b. The display controller 200 stored its composition results in a memory device 230. In the specific example, the display controller 200 is dedicated to the two active running applications, and the GPU is dedicated to the four less active running applications. It may seem like the lower GPU bears more composition load than the faster display controller at the time point. However, in following time points, the two active running applications generated more image layers than the four less active running applications. By dedicating the faster computing devices to the more active running applications, and dedicating the slower computing devices to the less active running applications, synchronization between the available computing devices was improved and the composition of the image layers was more efficient.

An output image may be obtained by implementing the above processing steps and will be sent to the display screen.

According to one embodiment, a system for image layer composition is provided.

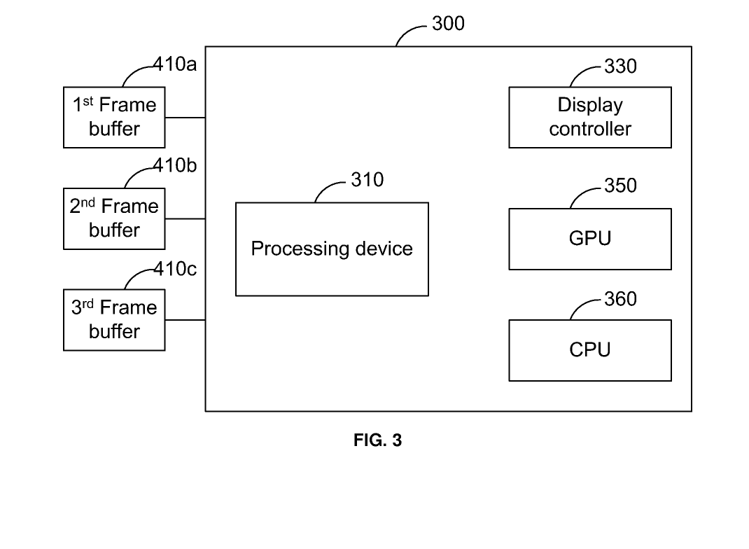

FIG. 3 schematically illustrates a block diagram of a system 300 for image layer composition.

The system 300 may include a processing device 310 and a plurality of computing devices including but not limited to a display controller 330, a GPU 350 and a CPU 370. In some embodiments, the processing device 310 may be embedded in the display controller 330. The processing device 310 may be configured as to: detect whether the plurality of computing devices have available resource for performing image layer composition; and control at least one computing device detected having available resource for performing image layer composition to compose a plurality of image layers.

Image layers may be generated by a plurality of running application and input into 1^{st}, 2^{nd} and 3^{rd} frame buffers 410a, 410b and 410c. It should be noted that the frame buffers are merely for illustration, the number of which may be changed. In some embodiments, the image layers may be controlled to transmit from the running applications directly to the computing devices to be composed therein. In some embodiments, the processing device 310 may be configured to detect information of the image layers in the frame buffers in a predetermined time interval. The time interval may be determined based on a refresh rate of a display screen which is going to show the composition result. Whether there are a plurality of image layers to be composed may be detected. In some embodiments, information of running applications regarding the image layers may be detected. Based on the detection of available computing devices and information of the image layers, the processing device 310 may be configured to control the computing devices detected having available resource to compose the image layers. Detail configurations may be obtained by referring above descriptions, which will not be illustrated in detail here.

According to one embodiment, a non-transitory computer readable medium, which contains a computer program for controlling composition of a plurality of image layers, is provided. When the computer program is executed by a processor, it will instruct the processor to: detect whether a plurality of computing devices of a computing system have available resource for performing image layer composition; and control at least one computing device detected having available resource for performing image layer composition to compose the plurality of image layers.

There is little distinction left between hardware and software implementations of aspects of systems; the use of hardware or software is generally a design choice representing cost vs. efficiency tradeoffs. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method for image layer composition, comprising:
detecting whether a plurality of computing devices of a computing system have available resources for performing image layer composition;
receiving a plurality of image layers; and
controlling at least one computing device detected having the available resources for performing image layer composition to compose the plurality of image layers.

2. The method according to claim 1, wherein the plurality of computing devices of the computing system comprise a graphic processing unit, a central processing unit and a display controller.

3. The method according to claim 1, wherein the plurality of computing devices of the computing system comprise at least two different types of devices.

4. The method according to claim 1, further comprising: determining computation capability required to compose the plurality of image layers, where the at least one computing device is controlled to compose the plurality of image layers based on the determination of the computation capability required to compose the plurality of image layers.

5. The method according to claim 1, wherein if one or more computing devices is detected having the available resources, the one or more computing devices detected having the available resources is controlled to compose the plurality of image layers based on composition speeds and computation loads.

6. A system for image layer composition, comprising a plurality of computing devices and a processing device, wherein the processing device is configured to:
detect whether the plurality of computing devices have available resources for performing image layer composition; and
control at least one computing device of the plurality of computing devices detected having the available resources for performing image layer composition to compose a plurality of image layers.

7. The system according to claim 6, wherein the plurality of computing devices of the system comprise a graphic processing unit, a central processing unit and a display controller.

8. The system according to claim 6, wherein the plurality of computing devices of the system comprise at least two different types of devices.

9. The system according to claim 6, wherein the processing device is further configured to: determine computation capability required to compose the plurality of image layers, and control the at least one computing device detected having the available resources for performing image layer composition to compose the plurality of image layers based on the determination of computation capability required to compose the plurality of image layers.

10. The system according to claim 6, wherein if one or more computing devices is detected to have the available resources, the processing device is configured to control the one or more computing devices detected having the available resources to compose the plurality of image layers based on composition speeds and computation loads.

11. The system of claim 6 wherein the processing device is further configured to detect whether the plurality of image layers are required to be composed prior to detecting whether the plurality of computing devices have available resources available.

12. The system of claim 11 wherein the processing device is further configured to detect whether the plurality of image layers are required to be composed by detecting information corresponding to the plurality of image layers in frame buffers.

13. The system of claim 12 wherein the processing device is further configured to detect the information corresponding to the plurality of image layers in the frame buffers within a predetermined time interval.

14. The system of claim 13 wherein the predetermined time interval is based on a refresh rate of a display screen which depicts a composition result.

15. The system of claim 12 wherein the processing device is further configured to compose the plurality of image layers based on the information and on the at least one computing device of the plurality of computing devices that is detected to have the available resources.

16. The method of claim 1 further comprising detecting whether the plurality of image layers are required to be composed prior to detecting whether the plurality of computing devices of the computing system have the available resources.

17. The method of claim 16 wherein detecting whether the plurality of image layers are required to be composed further comprises detecting information corresponding to the plurality of image layers in frame buffers.

18. The method of claim 17 wherein detecting the information corresponding to the plurality of image layers in the frame buffers further comprises detecting the information corresponding to the plurality of image layers in the frame buffers within a predetermined time interval.

19. The system of claim 17 further comprising composing the plurality of image layers based on the information and on the at least one computing device of the plurality of computing devices that is detected to have the available resources.

20. A non-transitory computer readable medium that includes a computer program executable by a processor for controlling composition of a plurality of image layers, the computer readable medium comprising:
instructions to detect whether a plurality of computing devices of a computing system have available resources for performing image layer composition; and
instructions to control at least one computing device of the plurality of computing devices detected having the available resource for performing image layer composition to compose the plurality of image layers.
